(19) United States
(12) Patent Application Publication
(10) Pub. No.: US 2021/0402922 A1
(43) Pub. Date: Dec. 30, 2021

(54) UNATTENTED OCCUPANT PROTECTION SYSTEM (UOPS) SAFETY SYSTEM

(71) Applicant: AAMP of Florida, Inc., Clearwater, FL (US)

(72) Inventor: Nathaniel Lee Wincek, New Port Richey, FL (US)

(21) Appl. No.: 17/325,794

(22) Filed: May 20, 2021

Related U.S. Application Data
(63) Continuation of application No. 16/015,338, filed on Jun. 22, 2018, now abandoned.
(60) Provisional application No. 62/523,879, filed on Jun. 23, 2017.

(51) Int. Cl. B60Q 9/00; B60N 2/00; B60R 16/037; B60H 1/00; G01V 3/08; G01V 9/00; G01V 1/00; G10L 25/78; G01V 8/10

(52) U.S. Cl. CPC B60Q 9/00; B60N 2/002; B60R 16/037; B60H 1/00978; G01V 3/08; G01V 9/005; G10L 25/51; B60H 1/00742; B60H 1/00757; B60H 1/00778; G10L 25/78; G01V 8/10; G01V 3/088; G01V 1/001

(57) ABSTRACT

Aspects of the disclosure relate to apparatus and methods for unattended occupant protection system (UOPS) safety systems for passenger vehicles. The UOPS safety system may include a UOPS module. The module may be integrated with a vehicle data bus of the passenger vehicle. The module may be in communication with a plurality of UOPS sensors. The module may launch an equalization mode in response to determining, via the UOPS sensors, the presence of an unattended occupant in the passenger vehicle with a high or rising ambient temperature. The equalization mode may stabilize the ambient temperature of the passenger vehicle.

### CROSS-REFERENCE TO RELATED APPLICATION

This application is a non-provisional of U.S. Provisional Patent Application No. 62/523,879 filed Jun. 23, 2017 entitled “VEHICLE DATA FUSION IN UNATTENDED OCCUPANT PROTECTION SYSTEM” which is hereby incorporated by reference herein in its entirety.

### FIELD OF TECHNOLOGY

Aspects of the disclosure relate to passenger vehicle safety systems. Specifically, aspects of the disclosure relate to unattended occupant protection systems for ambient temperature equalization.

### BACKGROUND OF THE DISCLOSURE

Passenger vehicles are a ubiquitous form of travel. Passenger vehicles may carry a variety of occupants. An occupant may be elderly. An occupant may be a baby, toddler, or young child. An occupant may be physically frail. An occupant may be dependent on others for situational awareness and/or mobility.

There is a risk of a driver inadvertently leaving an occupant unattended in a parked vehicle. The occupant may be silent. The occupant may be sleeping. The driver may be accustomed to one routine that does not involve an occupant. When following a second routine that does involve an occupant, the driver may forget that the occupant is in the vehicle.

Temperatures inside a parked passenger vehicle can reach dangerous levels in relatively short periods of time. Within a few minutes of a passenger vehicle being parked in the hot summer sun, the ambient temperature inside a passenger vehicle can reach fatally high levels. In the winter as well, ambient temperatures in a passenger vehicle can reach dangerously low levels. If left unattended inside a passenger vehicle, an occupant may be in significant danger.

As such, it would be desirable to provide an unattended occupant protection system (UOPS) safety system for passenger vehicles. It would be further desirable to provide a UOPS safety system for equalizing the ambient temperature in a passenger vehicle. Moreover, it would be desirable to provide an UOPS safety system for aftermarket integration with passenger vehicles.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative information in accordance with principles of the disclosure;

FIG. 1A shows illustrative information in accordance with principles of the disclosure;

FIG. 1B shows illustrative information in accordance with principles of the disclosure;

FIG. 1C shows illustrative information in accordance with principles of the disclosure;

FIG. 2 shows an illustrative process in accordance with principles of the disclosure;

FIG. 3 shows another illustrative process in accordance with principles of the disclosure;

FIG. 4 shows an illustrative system in accordance with principles of the disclosure;

FIG. 5 shows an illustrative process in accordance with principles of the disclosure; and

FIG. 6 shows an illustrative system in accordance with principles of the disclosure.

### DETAILED DESCRIPTION OF THE DISCLOSURE

Apparatus and methods for unattended occupant protection system (UOPS) safety systems for passenger vehicles are provided.

The apparatus and methods may involve the use of two or more information items. Information items may be processed by an onboard processor. One or more of the information items may be generated by an unattended occupant protection system (“UOPS”) sensor. The UOPS sensor may be an original equipment manufacturer (“OEM”) sensor. The UOPS sensor may be an aftermarket sensor.

One or more of the information items may be sourced from a UOPS variable. A UOPS variable may include information relating to the presence and/or state of an unattended occupant. A UOPS variable may be provided by a UOPS sensor.

One or more of the items may be sourced from a vehicle operational variable. A vehicle operational variable may include information relating to operation and/or a state of the vehicle. A vehicle operational variable may include a vehicle navigation system variable. The vehicle operational variable may be provided by an OEM sensor or algorithm. The vehicle operation variable may be provided by an aftermarket sensor or algorithm.

One or more of the items may be sourced from a person variable. A person variable may include information about the location and/or state of a driver or passenger of the vehicle. A person variable may be provided by a vehicle driver or a mobile communication device. The vehicle driver may manually provide information. The mobile communication device may be associated with the driver or a passenger.

One or more of the UOPS variables, vehicle operational variables or person variables may be converted into metadata for use with a rules-based alarm decision processor.

The apparatus and methods may include storage and use of one or more profiles. The apparatus and methods may use a profile to determine one or more of: which data to collect, what UOPS machine-executable rules to apply, what alarm action to take and any other suitable course of action. Table 1 (below) shows illustrative profile categories.

TABLE 1
Illustrative profile categories

Profile Category
Driver
Driver age
Driver gender
Vehicle make
Vehicle year
Vehicle model
Vehicle Color
Travel type (commute, pleasure, extended)
Region of travel
Season

Table 2 (below) shows illustrative UOPS sensors and corresponding information.

TABLE 2
Illustrative UOPS sensors and corresponding information.

| UOPS | Location(s) | | | |
|---|---|---|---|---|
| Sensor | (interior of vehicle) | Input Signal | Output Variable | UOPS Meta data |
| Infrared | Canopy, corner post, | Reception of | Relative thermal | Change over time |
| | side post, back of | thermal radiation | radiation flux of | in relative thermal |
| | seat (facing next seat | | target zone vs | radiation flux of |
| | to aft), door interior | | background | target zone vs |
| | | | | background |
| Optical-active | Canopy, corner post, | Reception of | Relative intensity | Change over time |
| visual spectrum | side post, back of | excitation light | of reflected | in relative intensity |
| detector | seat (facing next seat | reflection | excitation light | of reflected excitation |
| | to aft), door interior | | of target zone vs | light of target zone vs |
| | | | background. | background |
| Optical-passive | Canopy, corner post, | Reception of | Relative intensity | Change over time |
| visual spectrum | side post, back of | ambient light | of reflected light | in relative intensity |
| detector | seat (facing next seat | | of target zone vs | of reflected light of |
| | to aft), door interior | | background. | target zone vs |
| | | | | background. |
| Optical, | Canopy, corner post, | Object shape in | Object shape | Non-vehicle shape |
| camera array | side post, back of | visual or infrared | | detected |
| | seat (facing next seat | spectrum | | Body part detected |
| | to aft), door interior | | | Face detected |
| | | | | Eyes detected |
| | | | | Shape moved over time |
| | | | | Shape changed over time |
| | | | | Shape present after |
| | | | | door open/close. |
| | | | | Shape detected among |
| | | | | multiple shapes |
| | | | | Shape detected among |
| | | | | other shapes and |
| | | | | remains after door |
| | | | | open/close |
| Acoustic | Canopy, corner post, | 150-20,000 Hz | Presence of sound, | Presence of (or |
| | side post, back of | acoustic sampling; | presence of sound | change over time in) |
| | seat (facing next seat | one or more different | in frequency band, | human voice sound |
| | to aft), door interior | acoustic receivers or | presence of sound | Presence of (or |
| | | microphones for | statistically | change over time in) |
| | | frequency spectrum or | distinguishable from | guttural sound |
| | | parts of frequency | background sound; | Presence of (or |
| | | spectrum | Difference between | change over time in) |
| | | | interior sound and | breathing sound |
| | | | ambient sound | Presence of (or |
| | | | (exterior microphone) | change over time in) |
| | | | Acoustic signal | animal sound |
| | | | triangulated to source | Presence of (or |
| | | | in passenger location | change over time in) |
| | | | | material interaction |
| | | | | sound(fabric rustling, |
| | | | | plastic interactions, |
| | | | | metal interactions) |
| Gravimetric | Driver seat | Pressure on seat | Pressure on seat | Change over time in |
| | Passenger seat | | Weight of object | seat pressure |
| | | | on seat | Change over time in |
| | | | Areal extent of | object weight |
| | | | object on seat | Change over time in |
| | | | | extent of object on |
| | | | | seat |
| Capacitive | Driver seat | Matter on seat | Capacitance of | Change over time of |
| | Passenger seat | | object on seat | capacitance of object |
| | | | AC conductivity | on seat |
| | | | of object on seat | Change over time of |
| | | | Areal extent of | AC conductivity of |
| | | | object on seat | object on seat |
| | | | | Change over time of |
| | | | | areal extent of |
| | | | | object on seat |
| Solar flux | Exterior | Intensity of | Radiative flux | Ambient radiative |
| | | solar radiation | | flux (insolation) |
| | | | | Change over time in |
| | | | | radiative flux |
| | | | | Average radiative |
| | | | | flux over preselected |
| | | | | period |
| Temperature | Seat cushion | Temperature | Temperature | Temperature |
| | Seat back | | | Change over time of |
| | At interior of roof | | | temperature |
| | Below interior of | | | Average temperature |
| | roof | | | over preselected period |
| | Above interior of | | | Difference in |
| | floor | | | temperature between |
| | | | | different locations |
| | | | | in vehicle |
| | | | | Difference in |
| | | | | temperature between |
| | | | | seat component and |
| | | | | interior air temperature |

Table 3 (below) shows illustrative vehicle and person variables. Vehicle and person variables may be converted into metadata, which is not shown.

TABLE 3
Illustrative vehicle and person variables.
Vehicle/Person Variables

| | | Driver/Designated |
|---|---|---|
| | | Individual Variables |
| | Vehicle Navigation | (hand-held mobile |
| Vehicle Operational Variables | System Variables | communication device) |
| Lock status (locked/unlocked) | Vehicle location | Short range communication |
| (door/window/trunk/hatch) | | tether (RF, IR, Blue Tooth |
| Door (ID, open, close) | | (“BT”), WiFi) connected |
| Convertible top (open, closed) | Driver location (from | Tether range |
| Motor (on, off) | wireless entry device, fob, | |
| | driver cell phone), ETA | |
| Fuel (supply low/medium/high) | Emergency services | Last known position |
| | locations, ETA | |
| Battery (charge low/medium/high) | Pre-selected location, ETA | Vehicle monitoring |
| Window/sunroof (ID, open, close) | | app engaged |
| Collision prevention sensors | | |
| (proximity, velocity, frequency | | |
| of nearby vehicles) | | |
| Internal temperature | | |
| External temperature | | |
| Climate control system state | | |
| (thermostat setting, compressor | | |
| on/off, blower speed) | | |
| Time of day | | |
| Time elapsed after event | | |
| (driver door open/close, e.g.) | | |

One or more of the information items may be stored in machine-readable memory or broadcast periodically on a vehicle data bus. One or more of the variables may be stored in machine-readable memory or broadcast periodically on a vehicle data bus.

A processor in communication with the memory or the vehicle data bus or both may analyze an information item or a variable to determine whether it represents an alarm pre-condition in the context of a vehicle scenario. The processor may determine that the presence of two or more alarm pre-conditions requires activation of an alarm. A condition may relate to the likelihood of the presence of an unattended occupant. A condition may relate to the likelihood of injury to an unattended occupant.

Power for the apparatus and methods may be provided by a vehicle accessory power circuit. The circuit may be maintained in an energized state or in one or more different energized states. The energized state or states may provide sufficient power to operate UOPS sensors, vehicle operational variable sensors, vehicle navigation system sensors, processors, vehicle data bus controller and peripherals, and alert action devices.

The energized states may include a monitor state, which may monitor for UOP. The energized state may include an alert state, which may launch an alert.

Data fusion may be the process, or part of the process, by which the UOPS safety systems determines whether to launch an equalization state. Data fusion may include analyzing data gathered by UOPS sensors, or any other suitable data source. A processor may use machine logic to make the determination based on the data. Illustrative data fusion use cases are set forth below.

Illustrative Use Case A

Illustrative use case A may include a summer scenario, with high solar insolation, and interior temperature rising over 3-minute period from driver exit.

Table 4 (below) shows an illustrative information item fusion matrix for the scenario.

TABLE 4
Illustrative information item fusion matrix.

| Alarm pre-condition | Variable Values | | |
|---|---|---|---|
| | YES | NO | UNKNOWN |

UOPS State Variables

| | | | |
|---|---|---|---|
| A Warm body present | | | ✓ |
| B Reflective object present | | | ✓ |
| C Reflective object attitude change | ✓ | | |
| D Opaque object present | | | ✓ |
| E Non-vehicle shape present | ✓ | | |
| F Breathing sound present | | | ✓ |
| G Moving body sound present | | | ✓ |
| H Object present on seat | ✓ | | |
| I Low temperature condition present | | ✓ | |
| J High temperature condition present | ✓ | | |
| K Cooling condition present | | | ✓ |
| L Warming condition present | | | ✓ |
| M Solar radiation low | | ✓ | |
| N Solar radiation medium | | ✓ | |
| O Solar radiation high | ✓ | | |

Vehicle Operational Variables

| | | | |
|---|---|---|---|
| Open door present | | ✓ | |
| Motor on | | ✓ | |
| Fuel supply low | | | ✓ |
| Open window present | | ✓ | |
| Cabin temperature low | | ✓ | |
| Cabin temperature medium | | ✓ | |
| Cabin temperature high | ✓ | | |
| Elapsed time (from door open + close): | ✓ | | |
| greater than 5 minutes | | | |

Vehicle Navigation System Variables

| | |
|---|---|
| Vehicle location: distance from emergency | ✓ |
| services greater than 5 minutes | |
| Vehicle location: At pre-selected location | ✓ |
| Driver electronically tethered to vehicle | ✓ |

Machine-executable logic

| Spectral reflectance spike suggests moving | | |
|---|---|---|
| object. Presence of object corroborated by | | |
| detection of non-vehicle shape. High solar | | |
| radiation with rising interior temperature, | | |
| suggesting dangerous condition. | | |
| | YES | NO |
| INITIATE ALARM ACTION (e.g., BASED | ✓ | |
| ON MACHINE LOGIC)? | | |

Illustrative Use Case B

Illustrative use case B may include a summer scenario, with low observed solar insolation, suggesting clouds, shade or night conditions, with interior temperature stable, and driver tethered.

Table 5 (below) shows an illustrative information item fusion matrix for the scenario.

TABLE 5
Illustrative information item fusion matrix

| Alarm pre-condition | Variable Values | | |
|---|---|---|---|
| | YES | NO | UNKNOWN |

UOPS State Variables

| | | | |
|---|---|---|---|
| A Warm body present | | | ✓ |
| B Reflective object present | | | ✓ |
| C Reflective object attitude change | ✓ | | |
| D Opaque object present | | | ✓ |
| E Non-vehicle shape present | ✓ | | |
| F Breathing sound present | | | ✓ |
| G Moving body sound present | | | ✓ |
| H Object present on seat | ✓ | | |
| I Low temperature condition present | | | ✓ |
| J High temperature condition present | | | ✓ |
| K Cooling condition present | | ✓ | |
| L Warming condition present | | ✓ | |
| M Solar radiation low | ✓ | | |
| N Solar radiation medium | | ✓ | |
| O Solar radiation high | | ✓ | |

Vehicle Operational Variables

| | | |
|---|---|---|
| Open door present | | ✓ |
| Motor on | | ✓ |
| Fuel supply low | | ✓ |
| Open window present | ✓ | |
| Cabin temperature low | | ✓ |
| Cabin temperature medium | ✓ | |
| Cabin temperature high | | ✓ |
| Elapsed time (from door open + close): | | ✓ |
| greater than 5 minutes | | |

Vehicle Navigation System Variables

| | | |
|---|---|---|
| Vehicle location: distance from emergency | | ✓ |
| services greater than 5 minutes | | |
| Vehicle location: At pre-selected location | | ✓ |
| Driver electronically tethered to vehicle | ✓ | |

Machine-executable logic

| Spectral reflectance spike suggests moving | | |
|---|---|---|
| object. Presence of object corroborated by | | |
| detection of non-vehicle shape. Low solar | | |
| radiation, stable medium range interior | | |
| temperature, with corroborating UOPS and | | |
| vehicle temperatures, and tethered driver | | |
| suggest non-urgent condition. | | |
| | YES | NO |
| INITIATE ALARM ACTION (e.g., BASED | | ✓ |
| ON MACHINE LOGIC)? | | |

Illustrative Use Case C

Illustrative use case C may include a winter scenario, with low solar insolation, and interior temperature falling over 3-minute period from driver exit.

Table 6 (below) shows an illustrative information item fusion matrix for the scenario.

TABLE 6
Illustrative information item fusion matrix

| Alarm pre-condition | Variable Values | | |
|---|---|---|---|
| | YES | NO | UNKNOWN |

UOPS State Variables

| | | | |
|---|---|---|---|
| A Warm body present | ✓ | | |
| B Reflective object present | | ✓ | |
| C Reflective object attitude change | | ✓ | |
| D Opaque object present | ✓ | | |
| E Non-vehicle shape present | | | ✓ |
| F Breathing sound present | | | ✓ |
| G Moving body sound present | | | ✓ |
| H Object present on seat | ✓ | | |
| I Low temperature condition present | ✓ | | |
| J High temperature condition present | | | ✓ |
| K Cooling condition present | ✓ | | |
| L Wanning condition present | | ✓ | |
| M Solar radiation low | | ✓ | |
| N Solar radiation medium | | ✓ | |
| O Solar radiation high | ✓ | | |

Vehicle Operational Variables

| | | | |
|---|---|---|---|
| Open door present | | | ✓ |
| Motor on | | ✓ | |
| Fuel supply low | | | ✓ |
| Open window present | | | ✓ |
| Cabin temperature low | ✓ | | |
| Cabin temperature medium | | ✓ | |
| Cabin temperature high | | ✓ | |
| Elapsed time (from door open + close): | ✓ | | |
| greater than 5 minutes | | | |

Vehicle Navigation System Variables

| | |
|---|---|
| Vehicle location: distance from emergency | ✓ |
| services greater than 5 minutes | |
| Vehicle location: At pre-selected location | ✓ |
| Driver electronically tethered to vehicle | ✓ |

Machine-executable logic

| Warm body present, object on seat; low | | |
|---|---|---|
| temperature with cooling condition, | | |
| vehicle motor off, and driver exit | | |
| elapsed time greater than 5 minutes | | |
| suggest possible danger condition, | | |
| even though solar insolation is high. | | |
| | YES | NO |
| INITIATE ALARM ACTION (e.g., BASED | ✓ | |
| ON MACHINE LOGIC)? | | |

After reaching a decision to initiate an alarm action, the processor may launch one or more alarm action processes. Each process may include one or more alarm actions. Table 7 (below) shows illustrative alarm actions and priorities for one profile.

TABLE 7
Illustrative alarm actions and priorities for profile n.

| | Priority Tier |
|---|---|
| Alarm Action | (Profile n) |
| Lower window | 3 |
| Lock window | 4 |
| Unlock widow | 4 |
| Lock door | 4 |
| Unlock door | 3 |
| Open hatch door | 4 |
| Sound vehicle horn | 2 |
| Engage vehicle speaker/annunciator to | 3 |
| announce alarm | |
| Flash vehicle head lights | 2 |
| Flash exterior alert light (standardized | 2 |
| UOPS color, form factor) | |
| Contact user(s) from user list (cell, | 1 |
| landline, email, text, Instagram, etc.) | |
| Contact emergency services (possibly | 3 |
| dependent upon interior temperature) | |
| Notify parking attendant/security patrol | 2 |
| Buzz-back or signal to remote key or fob | 1 |
| (initially, if object registered prior to | |
| travel and not removed after driver door | |
| open/close, and then follow-up if dynamic/ | |
| motion signal received). | |
| Turn on motor (e.g., by activating remote | 4 |
| start) and use climate control system to | |
| keep interior with acceptable temperature | |
| limits (monitor fuel, broadcast predicted | |
| run-time). | |
| Navigate to default or preselected | 5 |
| destination, such as one or more of those | |
| identified in Navigation System Variables, | |
| Table 3, above. Provide ETA by phone, text, | |
| email, public or private secure or non- | |
| secure WAN or LAN, etc., to one or more | |
| of driver, preselected entities, public | |
| safety representative, hospital, etc. | |

Communication between the UOPS system and a party outside the vehicle may be performed via a mobile communication device tethered to the phone. Communication between the UOPS system and a party outside the vehicle may be performed via an on-board telematic system. Communication between the UOPS system and a party outside the vehicle may be performed via an aftermarket telecommunication device. mobile communication device tethered to the phone.

The party may be a custom selected party. The UOPS may be preprogrammed to engage a stored telephone number of the party. The party may be a party that provides further communication to emergency services.

The UOPS may establish an audio feed from the vehicle to the party or emergency services. The UOPS may establish a video feed from the vehicle to the party or emergency services.

Each alarm action may be assigned a priority tier. Each priority tier may include one or more alarm actions. The processor may initiate alarm actions in a sequence, such as by initiating one or more alarm actions from Tier 1, then one or more alarm actions from Tier 2, Tier m, etc. The assignment of alarm actions to different tiers may be different for each profile. Tiers for Profile n are identified in Table 7 as an example.

The processor may provide an alarm instruction to an alarm system. The alarm system may be separate from the UOPS module. The alarm system may be separate from the UOPS safety system. The alarm system may initiate the alarm action. The alarm system may be programmable to select an alarm action. The instruction may include one or more parameters. The one or more parameters may include one or more alarm pre-conditions. The alarm system may read the one or more parameters. The alarm system may select an alarm action based on the presence or absence of one or more of the alarm parameters. The processor may output the instruction to a vehicle data bus.

An aftermarket safety system for passenger vehicles is provided. The safety system may include a plurality of unattended occupant protection system (UOPS) sensors. The plurality of UOPS sensors may include a first set of UOPS sensors, a second set of UOPS sensors, and a third set of UOPS sensors.

The safety system may include a module. A module may be alternatively referred to herein as a UOPS module. The module may include a processor and a non-transitory machine-readable memory for storing data detected by the UOPS sensors. The memory may also store machine-executable instructions. The machine-executable instructions may provide logic for the processor to run at least a part of the UOPS safety system.

The first set of UOPS sensors may be for positioning relative to a passenger's seat of the passenger vehicle. The second set of UOPS sensors may be for positioning relative to a driver's seat of the passenger vehicle. The third set of UOPS sensors may include a temperature sensor for detecting a temperature in the passenger vehicle. The third set of UOPS sensors may be for positioning in any suitable location in the passenger vehicle.

The module may be for installation in the passenger vehicle. In some embodiments, the module may include components that are removable from the vehicle. In certain embodiments, the module may include a mobile phone. The mobile phone may include a UOPS application.

The module may be configured to communicate with the plurality of UOPS sensors. The module may also be configured to integrate with a vehicle data bus. Integration with a vehicle data bus may enable the module to communicate with and/or control some or all of the components of the passenger vehicle.

The safety system may be configured to draw power from a battery of the passenger car even when the passenger car is in an off state. In some embodiments, the safety system may include a power source independent of the passenger vehicle battery. The independent power source may be a battery. The independent power source may include solar power.

The safety system may be configured to be in a monitor state. The monitor state may be the default state of the safety system. In some embodiments, the monitor state may be activated manually. In certain embodiments, the monitor state may be activated automatically when the passenger vehicle is in park.

In a monitor state, the plurality of UOPS sensors may periodically or substantially continuously update data in the memory and/or vehicle data bus. When the processor determines that an unattended occupant is present with an unsafe environment, the processor may launch an equalization mode.

The processor's determination of the presence of an unattended occupant in an unsafe environment may follow the confluence of multiple factors. For example, a first set of UOPS sensors may detect a physical presence of a passenger sitting in the passenger's seat of the passenger vehicle. A second set of UOPS sensors may detect an absence of the driver sitting in the driver's seat of the passenger vehicle. A third set of UOPS sensors may detect either an unsafe temperature in the passenger vehicle, or a delta in the temperature in the passenger vehicle over a three-minute timespan. Based on detection of these three events, the processor may launch an equalization mode.

An unsafe temperature may include a temperature that is outside of a safe range. A safe range may be from 65 to 80 degrees Fahrenheit. A safe range may be any other suitable range of temperatures. A safe range may be based on a location of the vehicle.

In an equalization mode, the processor may stabilize the temperature in the passenger vehicle to within the range from 65 to 80 degrees Fahrenheit. The processor may accomplish this by providing power to one or more vehicle components. The processor may take control of one or more vehicle components. For example, the processor may open one or more windows, sunroofs, doors and/or hatches of the passenger vehicle. The processor may activate a climate control of the vehicle. The processor may direct the opening and/or activating over the vehicle data bus.

In some embodiments, the processor in an equalization mode may direct all the resources at its disposal to bring the temperature to within the range from 65 to 80 degrees Fahrenheit as quickly as possible. Once that is accomplished, the processor may use only some or part of the resources to maintain the temperature in the range. For example, the processor may detect a temperature in the vehicle of 100 degrees Fahrenheit. The processor may then launch an equalization mode and open all the passenger vehicle windows and also turn on the air conditioner to a maximum setting. When the temperature in the vehicle is lowered to 72 degrees, the processor may turn off the air conditioner and leave only two windows open. This may be sufficient to maintain the temperature within the range.

In some embodiments, the safety system may include equalization devices for equalizing the temperature. Equalization device may include water or mist sprinklers, fans, and heat emitting devices.

In certain embodiments of the safety system, at least one of the second set of UOPS sensors may be a capacitive sensor for detecting capacitance on the driver's seat. The processor's determination that the capacitive sensor detects the absence of a driver sitting in the driver's seat may be responsive to a delta in the detected capacitance on the driver's seat.

In some embodiments, the safety system may further include at least a first vehicle operational sensor. The first vehicle operational sensor may be for detecting an opening event and a closing event of a driver's door of the passenger vehicle. In this embodiment, the processor's determination that the second set of UOPS sensors detects the absence of a driver sitting in the driver's seat includes a detection of an absence that occurs after an opening event of the driver's door and before a closing event of the driver's door.

In certain embodiments of the safety system, at least one of the second set of UOPS sensors may be a camera array for detecting images. The camera array may include a video camera. The processor's determination that the camera array detects the absence of a driver sitting in the driver's seat may be responsive to images and/or video associated with an empty driver's seat. The processor may employ image processing, computer vision, artificial intelligence (AI) and/or machine learning (ML) techniques to assist in the determination.

In some embodiments of the safety system, at least one of the first set of UOPS sensors may be a capacitive sensor for detecting capacitance on the passenger's seat. The processor's determination that the capacitive sensor detects the physical presence of a passenger sitting in the passenger's seat may be responsive to a level of detected capacitance on the passenger's seat that is greater than the typical capacitance detected on the passenger seat when the passenger car is in an off state. The typical capacitance detected on the passenger seat when the passenger car is in an off state may include capacitance due to a seat cover or a protective car seat. The processor's determination may also be responsive to a fluctuation in the capacitive patterns, which may indicate movement on the passenger's seat.

In certain embodiments of the safety system, at least one of the first set of UOPS sensors may be a gravimetric sensor for detecting a pressure on the passenger's seat. The gravimetric sensor may include an occupant classification system (OCS). The processor's determination that the gravimetric sensor detects the physical presence of a passenger sitting in the passenger's seat may be responsive to a level of detected pressure on the passenger's seat that is greater than the typical pressure detected on the passenger seat when the passenger car is in an off state. The typical capacitance pressure on the passenger seat when the passenger car is in an off state may include pressure due to a seat cover or a protective car seat. The processor's determination may also be responsive to a fluctuation in the detected pressure, which may indicate movement on the passenger's seat.

In some embodiments of the safety system, at least one of the first set of UOPS sensors may be an infrared sensor for detecting thermal radiation emanating from a region on the passenger's seat. The infrared sensor may be installed at a canopy, corner post, side post, door interior, and/or rear of a front row seat of the passenger vehicle. The processor's determination that the infrared sensor detects the physical presence of a passenger sitting in the passenger's seat may be responsive to a delta in relative thermal radiation flux of the region on the passenger's seat versus a background of the passenger vehicle.

In certain embodiments of the safety system, at least one of the first set of UOPS sensors may be an acoustic sensor for detecting sound. The processor's determination that the acoustic sensor detects the physical presence of a passenger sitting in the passenger's seat may be responsive to a pattern of sound associated with human voice, human crying, human breathing, or any other suitable pattern indicative of a human presence.

In some embodiments of the safety system, at least one of the first set of UOPS sensors may be an optical sensor for detecting light. The optical sensor may be an optical-active visual spectrum detector or an optical-passive visual spectrum detector. The processor's determination that the optical sensor detects the physical presence of a passenger sitting in the passenger's seat, may be responsive to a pattern of detected light that is associated with movement of a human sitting in the passenger's seat.

In certain embodiments of the safety system, at least one of the first set of UOPS sensors may be a camera array for detecting images. The processor's determination that the camera array detects the physical presence of a passenger sitting in the passenger's seat may be responsive to images associated with a human sitting in the passenger's seat.

In some embodiments, the safety system may be configured to be in a monitor state when a transmission of the passenger vehicle is set to a park mode. In certain embodiments, the safety system may be configured to exit an equalization mode when the transmission is removed from a park mode. In some embodiments, a predesignated driver may manually exit an equalization mode.

In certain embodiments, the safety system may further comprise a UOPS alert horn and a UOPS alert beacon for positioning on an exterior of the passenger vehicle. The equalization mode may further include sounding the UOPS alert horn and flashing the UOPS alert beacon.

In some embodiments of the safety system, the equalization mode may further include the processor directing the passenger vehicle to drive autonomously to the nearest location from a list including a hospital, police station, and fire station. The direction may include communication over the integrated vehicle data bus.

In some embodiments of the safety system, the module may include a connection to a communication network. The module may have a connection to a cellular communication network. The module may have a connection to the internet. The connection may be accomplished via a communication component native to the module. In some embodiments, the connection may be via the integration with the vehicle data bus of the passenger vehicle, and a component of the passenger vehicle may be connected to a communication network. In an equalization mode, the module may send an emergency message to a predesignated driver and emergency services. The sending may be accomplished directly, or indirectly via the integrated vehicle data bus.

A passenger vehicle configured with an unattended occupant protection system (UOPS) is provided. The passenger vehicle may include a plurality of UOPS sensors. The UOPS sensors may include at least a first, second, and third set of UOPS sensors. The first set of UOPS sensors may be for detecting a physical presence of a passenger sitting in a passenger's seat of the passenger vehicle. The second set of UOPS sensors may be for detecting an absence of a driver sitting in a driver's seat of the passenger vehicle. The third set of UOPS sensors may be for detecting a temperature in the passenger vehicle. The third set of UOPS sensors may include a temperature sensor.

The passenger vehicle may include a non-transitory machine-readable memory for storing data detected by the UOPS sensors. The passenger vehicle may also include a vehicle data bus for broadcasting data detected by the UOPS sensors. The passenger vehicle may include a processor in communication with the memory and/or vehicle data bus.

The passenger vehicle may be configured to be in a monitor state. In a monitor state, the plurality of UOPS sensors may periodically or substantially continuously update data in the memory and/or vehicle data bus. When the processor determines that: the first set of UOPS sensors detect a physical presence of a passenger sitting in the passenger's seat of the passenger vehicle; the second set of UOPS sensors detect an absence of the driver sitting in the driver's seat of the passenger vehicle; and the third set of UOPS sensors detect either a temperature in the passenger vehicle that is outside of the range from 65 to 80 degrees Fahrenheit, or a delta in the temperature in the passenger vehicle over a three-minute timespan; the processor may launch an equalization mode. An equalization mode may stabilize the temperature in the passenger vehicle to within the range from 65 to 80 degrees Fahrenheit. The equalization mode may open one or more windows, sunroofs, doors and/or hatches of the passenger vehicle. The equalization mode may activate a climate control of the vehicle.

In some embodiments of the passenger vehicle, at least one of the second set of UOPS sensors may be a gravimetric sensor for detecting a pressure on the driver's seat. The processor's determination that the gravimetric sensor detects the absence of a driver sitting in the driver's seat may be responsive to a delta in the detected pressure on the driver's seat.

In certain embodiments of the passenger vehicle, at least one of the first set of UOPS sensors may be an infrared sensor for detecting thermal radiation emanating from a region on the passenger's seat. The infrared sensor may be installed at a canopy, corner post, side post, door interior, and/or rear of a front row seat of the passenger vehicle. The processor's determination that the infrared sensor detects the physical presence of a passenger sitting in the passenger's seat may be responsive to a delta in relative thermal radiation flux of the region on the passenger's seat versus a background of the passenger vehicle.

In some embodiments of the passenger vehicle, at least one sensor of the first or second sets of UOPS sensors may be an optical sensor for detecting light. The optical sensor may be an optical-active visual spectrum detector. The optical-active visual spectrum detector may stimulate excitation of particles to detect. The optical sensor may be an optical-passive visual spectrum detector. The optical sensor may be a camera array. The processor's determination that the optical sensor detects the physical presence of a passenger sitting in the passenger's seat, or detects the absence of a driver sitting in the driver's seat, may be responsive to a pattern of detected light that is associated with a human sitting in the passenger's seat or an empty driver's seat.

In some embodiments, the passenger vehicle may be configured to be in a monitor state when a transmission of the passenger vehicle is set to a park mode.

A method for equalizing the ambient temperature in a passenger vehicle using an unattended occupant protection system (UOPS) safety system is provided. The UOPS safety system may include a first set of UOPS sensors installed relative to a passenger's seat of the passenger vehicle. The UOPS safety system may also include a second set of UOPS sensors installed relative to a driver's seat of the passenger vehicle. The UOPS safety system may also include a third set of UOPS sensors installed in the passenger vehicle for detecting the ambient temperature. The third set of UOPS sensors may include a temperature sensor.

The UOPS safety system may include a UOPS module. The UOPS module may be installed in the passenger vehicle. The UOPS module may be a mobile phone. The UOPS module may include a processor. The UOPS module may include a non-transitory machine-readable memory for storing data detected by the UOPS sensors.

The UOPS module may be configured to communicate with the UOPS sensors. The UOPS module may be configured to integrate with a vehicle data bus.

The method may include toggling the UOPS module to be in a monitor state. The monitor state may include the plurality of UOPS sensors periodically or substantially continuously updating data in the memory and/or vehicle data bus.

The method may include the processor launching an equalization mode upon determination of three events. First, the first set of UOPS sensors detecting a physical presence of a passenger sitting in the passenger's seat of the passenger vehicle. Second, the second set of UOPS sensors detecting an absence of a driver sitting in the driver's seat of the passenger vehicle. Third, the third set of UOPS sensors detecting either a temperature in the passenger vehicle that is outside of a range from 65 to 80 degrees Fahrenheit, or a delta in a temperature in the passenger vehicle over a three-minute timespan.

The equalization mode may include the processor stabilizing the temperature in the passenger vehicle to within the range from 65 to 80 degrees Fahrenheit. The processor may accomplish this by opening one or more windows, sunroofs, doors and/or hatches of the passenger vehicle, and/or activating a climate control of the vehicle. The processor may direct the opening and/or activating via communication with the vehicle data bus with which the processor may be integrated.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

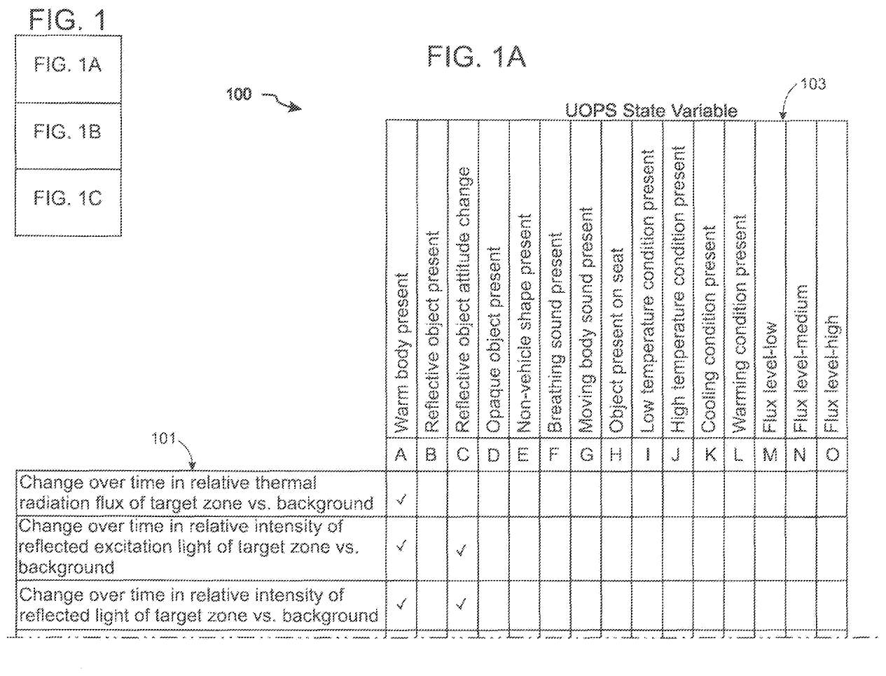

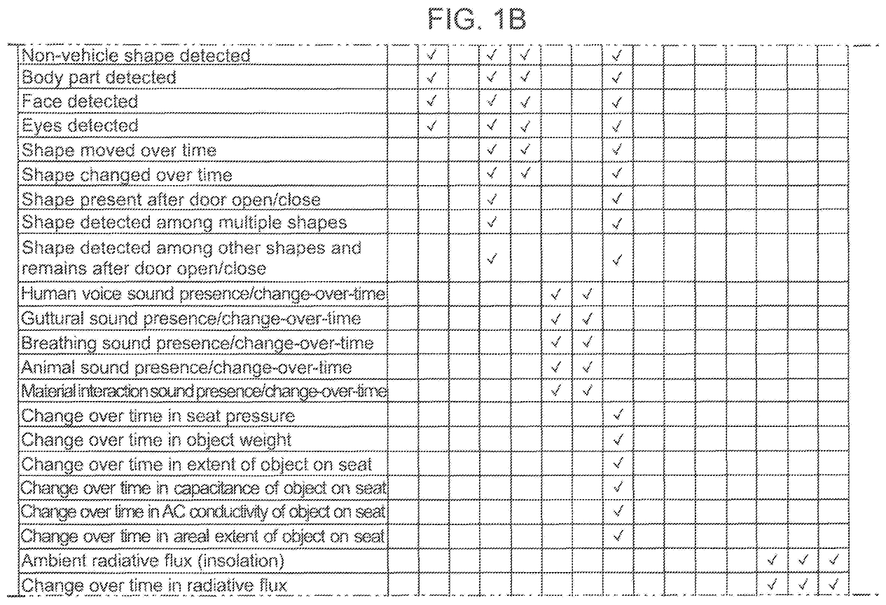

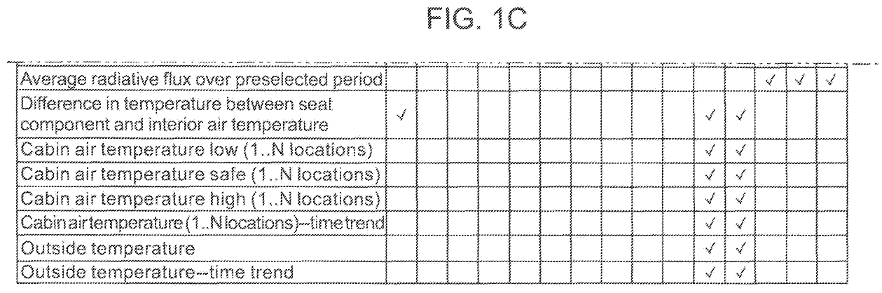

FIG. 1 shows illustrative information 100. FIG. 1 includes FIG. 1A, FIG. 1B, and FIG. 1C. Information 100 shows an illustrative correspondence matrix between UOPS metadata 101 and UOPS state variables 103. The UOPS state variables may be defined based on one or more corresponding UOPS metadata values. The UOPS state variables may be defined in such a way as to serve as input to a rules engine that is configured to determine whether an alarm precondition is present.

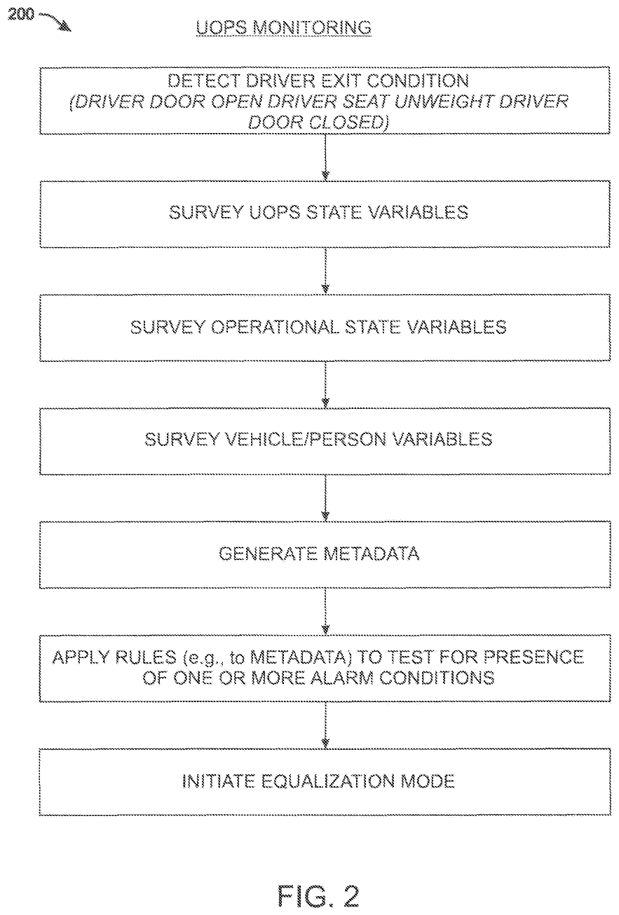

FIG. 2 shows illustrative flowchart 200. Flowchart 200 represents steps of a procedure for fusing data in conformance with the principles of the disclosure.

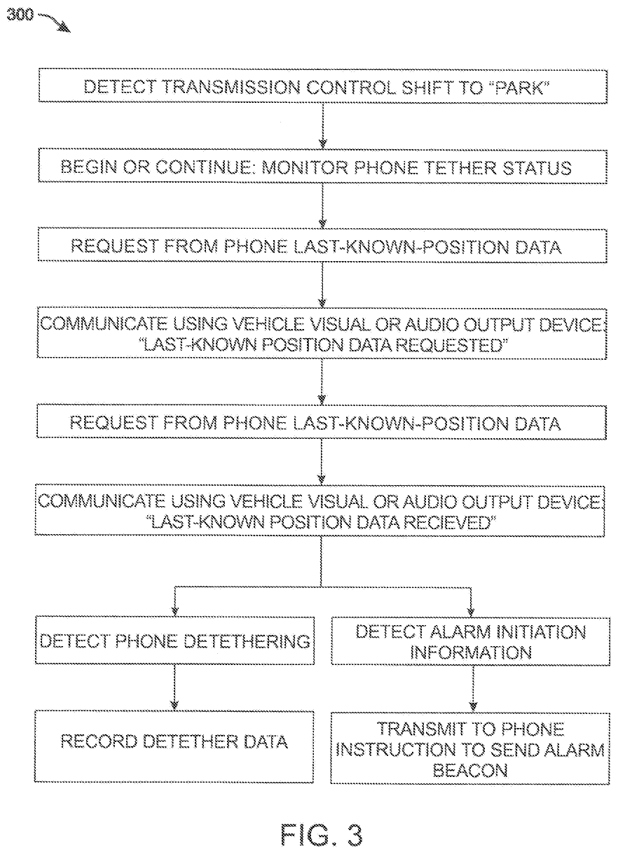

FIG. 3 shows illustrative flowchart 300. Flowchart 300 represents steps of a method for monitoring the last known position of a driver or designated person. The position may be recorded in response to a shift of a transmission control into the “Park” position. The position may be recorded in response to a detection of a detethering from the vehicle of a mobile communication device.

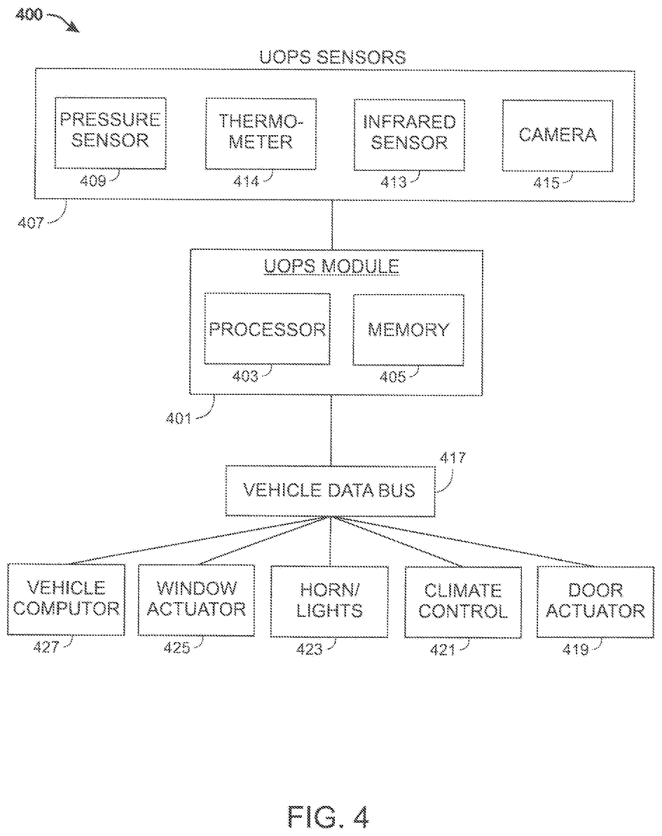

FIG. 4 shows illustrative system 400. System 400 represents an integrated UOPS safety system. UOPS module 401 may contain processor 403 and memory 405. UOPS module may be connected to, or otherwise in communication with, UOPS sensors 407. UOPS sensors 407 may include at least one pressure sensor 409, at least one thermometer 411, at least one infrared sensor 413, and/or at least one camera 415.

UOPS module 410 may be connected to, or otherwise integrated with, vehicle data bus 417. Vehicle data bus 417 may be connected to, or otherwise in communication with, a plurality of components. The components may include at least one door actuator 419, climate control 421, horn/lights 423, at least one window actuator 425, and/or vehicle computer 427.

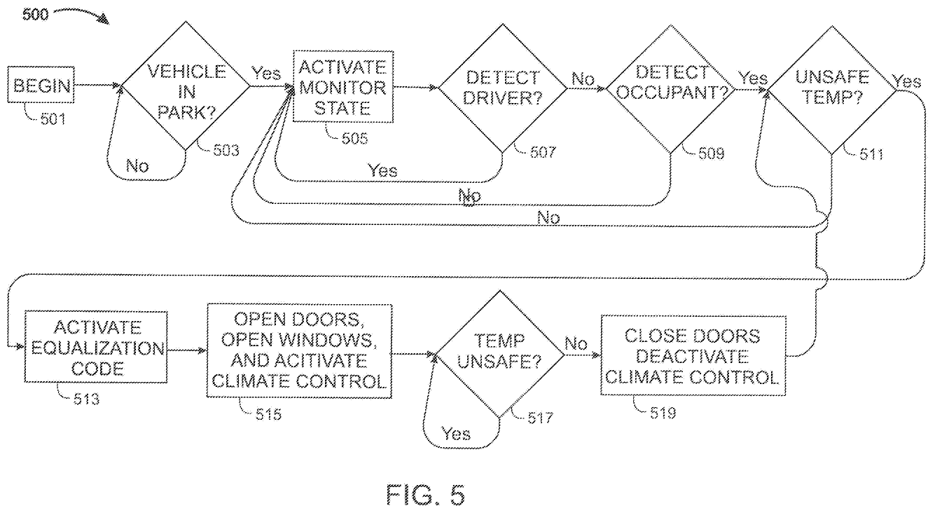

FIG. 5 shows illustrative flowchart 500. Flowchart 500 represents steps of a method for equalizing ambient temperature with a UOPS safety system.

Flowchart 500 begins at step 501. At step 503, the method checks whether the vehicle is in park. If the vehicle is not in park, the method periodically or substantially continuously revisits step 503. If the vehicle is in park, the method proceeds to step 505 and a monitor state is activated. In the monitor state, the method periodically or substantially continuously proceeds to step 507 and checks whether a driver is detected. If yes, the method revisits step 505. If not, the method proceeds to step 509, which queries whether an occupant is detected. If not, the method returns to step 505. If yes, the method proceeds to step 511, which queries whether an unsafe temperature is detected. If not, the method returns to step 505. If yes, the method proceeds to step 513, and launches an equalization mode. In the equalization mode, the method proceeds to step 515 and opens doors and windows, and activates a climate control of the passenger vehicle. The method then proceeds to step 517, which queries whether an unsafe temperature is still detected. If yes, the method periodically or substantially continuously revisits step 517. If not, the method proceeds to step 519. At step 519 the method closes the doors and deactivates the climate control, while leaving open the windows to maintain the safe temperature. The method then periodically or substantially continuously returns to step 511 and for an unsafe temperature.

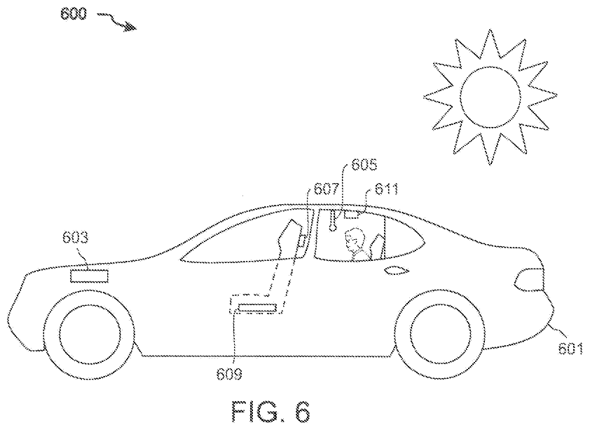

FIG. 6 shows illustrative system 600. System 600 includes a passenger vehicle 601. System 600 may include UOPS module 603. UOPS module 603 may be integrated with components of passenger vehicle 601. For example, UOPS module 603 may be installed in an engine compartment of passenger vehicle 601. In another embodiment (not shown), UOPS module may be installed in a dashboard or a trunk compartment of passenger vehicle 601.

System 600 may include a thermometer 605. Thermometer 605 may be installed at a ceiling of passenger vehicle 601.

System 600 may also include a UOPS sensor 607. UOPS sensor 607 may be installed in or on the rear of a front row seat, facing a rear passenger's seat. UOPS sensor 607 may be able to detect the presence of a passenger in the passenger's seat. In one example, UOPS sensor 607 may be a camera. In another example, UOPS sensor 607 may be an infrared sensor or any other suitable sensor.

System 600 may also include a UOPS sensor 609. UOPS sensor 609 may be installed in or on the driver's seat of the passenger vehicle. UOPS sensor 609 may be able to detect the presence of a driver in the driver's seat. In one example, UOPS sensor 607 may be a pressure sensor. In another example, UOPS sensor 607 may be a capacitive sensor or any other suitable sensor.

System 600 may also include an equalization device 611. Equalization device 611 may be installed at the ceiling of the passenger vehicle above the passenger's seat. Equalization device 611 may be able to stabilize a temperature in the passenger vehicle. In one example, equalization device 611 may be a fan. In another example, equalization device 611 may be a mist emitter or any other suitable device.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for unattended occupant protection systems for ambient temperature equalization are provided. Persons skilled in the art will appreciate that the present invention can be practiced by other than the described embodiments, which are presented for purposes of illustration rather than of limitation, and that the present invention is limited only by the claims that follow.

1-20. (canceled)

21. A safety system for a vehicle, the system comprising:
a driver occupancy sensor;
a passenger occupancy sensor;
a temperature sensor configured to detect a temperature within the vehicle; and
an electronic processor operatively coupled to the driver occupancy sensor, the passenger sensor, and the temperature sensor, the electronic processor configured, in response to determining the vehicle is in a parked state, to:
determine, via the driver occupancy sensor, whether a driver of the vehicle is present in a driver seat,
determine, via the passenger occupancy sensor, whether a passenger of the vehicle is present in a passenger seat,
determine, via the temperature sensor, a temperature within the vehicle, and
operate, in response to a set of conditions being met, a safety feature of the vehicle, the set of conditions including at least:
1) as determined via the passenger occupancy sensor, the passenger of the vehicle is present in the passenger seat,
2) as determined via the driver occupancy sensor, the driver of the vehicle is not present in the passenger seat, and
3) the sensed temperature is outside of a predetermined temperature range.

22. The system of claim 21, wherein at least one of the driver occupancy sensor and the passenger occupancy sensor is a pressure sensor configured to detect a pressure on at least one of the driver seat and the passenger seat of the vehicle.

23. The system of claim 21, wherein the driver occupancy sensor detects, in response to an opening event and a closing event of a door of the vehicle, the presence or absence of the driver.

24. The system of claim 21, wherein at least one of the driver occupancy sensor and the passenger occupancy sensor includes a camera configured to detect the presence or absence of an occupant in at least one of the driver seat and the passenger seat of the vehicle.

25. The system of claim 21, wherein at least one of the driver occupancy sensor and the passenger occupancy sensor includes a capacitive sensor configured to detect capacitance of at least one of the driver seat and the passenger seat of the vehicle, and wherein the electronic processor is further configured to determine, based on the information sensed by the capacitive sensor, at least one of when the passenger of the vehicle is present in the passenger seat and when the driver of the vehicle is not present in the driver seat.

26. The system of claim 21, wherein at least one of the driver occupancy sensor and the passenger occupancy sensor includes an infrared sensor configured to detect thermal radiation emanating from a region on at least one of the driver seat and the passenger seat of the vehicle.

27. The system of claim 21, wherein the passenger occupancy sensor includes an acoustic sensor configured to detect sound, and wherein the electronic processor is further configured to determine when the passenger of the vehicle is present in the vehicle by comparing the sensed sound to a pattern of sound associated with at least one selected from a group consisting of sounds made by a human and sounds made by an animal.

28. The system of claim 21, wherein at least one of the driver occupancy sensor and the passenger occupancy sensor includes an optical sensor configured to detect light, wherein the optical sensor is one selected from a group consisting of an optical-active visual spectrum detector and an optical-passive visual spectrum detector.

29. The system of claim 21, wherein operating the safety feature of the vehicle includes at least one selected from a group consisting of activating an alarm of the vehicle and transmitting an alert to an electronic communication device remote from the vehicle.

30. The system of claim 21, wherein operating the safety feature of the vehicle includes at least one selected from a group consisting of opening a window of the vehicle, closing a window of the vehicle, unlocking a door of the vehicle, and opening a door of the vehicle.

31. The system of claim 21, wherein operating the safety feature of the vehicle includes activating at least one of a heating system or a cooling system of the vehicle until the temperature of the vehicle is within the predetermined temperature range.

32. The system of claim 21, wherein the electronic processor is configured to draw power from a battery of the vehicle even when the vehicle is in an off state.

33. The system of claim 21, wherein the electronic processor is further configured to
determine the existence of one or more alarm pre-conditions, and
input the one or more alarm pre-conditions into a data matrix.

34. The system of claim 33, wherein the one or more alarm pre-conditions is indicative of a likelihood of the passenger being present in the vehicle.

35. The system of claim 33, wherein the alarm-precondition is indicative of a likelihood of an injury to the passenger of the vehicle.

36. The system of claim 21, wherein the electronic processor is further configured to:
determine a rate of change of the temperature within the vehicle, and
wherein operating the safety feature of the vehicle is at least partially based on the rate of change of the temperature.

37. A method of operating a vehicle, the method comprising:
determining, by an electronic processor, when the vehicle is in a parked state;
entering, in response to determining the vehicle is in a parked state, a monitoring state of the vehicle;
receiving, by the electronic processor, a signal from a driver occupancy sensor, the driver occupancy sensor configured to sense whether a driver is present in a driver seat of the vehicle;
receiving, by the electronic processor, a signal from a passenger occupancy sensor, the passenger occupancy sensor configured to sense whether a passenger is present in a passenger seat of the vehicle;
receiving, by the electronic processor, a signal from a temperature sensor, the signal indicative of a temperature within the vehicle; and
operating, via the electronic processor, a safety feature of the vehicle in response to a set of conditions being met, the set of conditions including at least:
1) as determined via the passenger occupancy sensor, the passenger of the vehicle is present in the passenger seat,
2) as determined via the driver occupancy sensor, the driver of the vehicle is not present in the passenger seat, and
3) the sensed temperature is outside of a predetermined temperature range.

38. The method of claim 37, wherein operating the safety feature of the vehicle includes at least one of activating an alarm and transmitting an alert to an electronic communication device remote from the vehicle.

39. The method of claim 37, wherein operating the safety feature of the vehicle includes at least one selected from a group consisting of unlocking a door of the vehicle, opening a door of the vehicle, opening a window of the vehicle, and closing a window of the vehicle.

40. The method of claim 37, wherein operating the safety feature of the vehicle includes activating at least one of a heating system or a cooling system of the vehicle until the temperature is within the predetermined temperature range.

41. The method of claim 37, wherein operating the safety feature of the vehicle includes controlling a plurality of vehicle sub-systems to autonomously drive the vehicle to a location selected from a group consisting of a hospital, a police station, and a fire station.

42. The method of claim 37, further comprising determining the existence of one or more alarm pre-conditions, and inputting the one or more alarm pre-conditions into a data fusion matrix, wherein the one or more alarm pre-conditions is indicative of at least one of a likelihood of the passenger being present in the vehicle and a likelihood of injury to the passenger of the vehicle.

43. The method of claim 37, further comprising determining a rate of change of the temperature within the vehicle, and wherein the set of conditions further includes 4) the rate of change of the temperature is above a predetermined threshold.

44. The method of claim 37, further comprising:
selecting the safety operation from a plurality of safety operations, each safety operation of the plurality of safety operations including a priority tier, and
wherein activating the safety operation includes activating the one of the plurality of safety operations with the lowest priority tier.

45. The method of claim 44, wherein activating the one of the plurality of safety operations includes
activating the one or of the plurality of safety operations with the lowest priority tier for a predetermined time period, and further comprising
in response to completion of the predetermined time period, activating another one of the plurality of safety operations with a priority tier greater than the lowest priority tier.

46. The method of claim 37, further comprising launching, in response to the vehicle being placed in a parked state, an equalization mode, wherein, when in equalization mode, the electronic processor is configured to monitor the set of conditions.

47. The method of claim 46, further comprising exiting the equalization mode when the vehicle is no longer in the parked state.

48. The method of claim 37, wherein operating the safety feature of the vehicle includes activating at least one of a heating system or a cooling system of the vehicle until the temperature is between 65 degrees to 80 degrees Fahrenheit.

49. A safety system for a vehicle, the system comprising:
a driver occupancy sensor;
a passenger occupancy sensor;
a temperature sensor configured to detect a temperature within the vehicle; and
an electronic processor operatively coupled to the driver occupancy sensor, the passenger sensor, and the temperature sensor, the electronic processor configured to:
determine, via the driver occupancy sensor, whether a driver of the vehicle is present in a driver seat of the vehicle,
determine, via the passenger occupancy sensor, whether a passenger of the vehicle is present in a passenger seat of the vehicle,
determine, via the temperature sensor, whether a temperature within the vehicle is within a predetermined temperature range, and
activate, in response to a set of conditions being met, a climate control system, the set of conditions including at least:
1) as determined via the passenger occupancy sensor, the passenger of the vehicle is present in the passenger seat,
2) as determined via the driver occupancy sensor, the driver of the vehicle is not present in the passenger seat, and
3) the sensed temperature is outside of a predetermined temperature range,
wherein activating the climate control system includes activating the climate control system until the temperature is within the predetermined temperature range.

50. The system of claim 49, wherein the electronic processor is further configured to determine when the vehicle is in a parked state, and
launch, in response to determining the vehicle is in a parked state, an equalization mode, wherein, when in equalization mode, the electronic processor is configured to monitor the set of conditions.
